(19) United States
(12) Patent Application Publication
(10) Pub. No.: US 2025/0197277 A1
(43) Pub. Date: Jun. 19, 2025

(54) TRANSPARENT COMPONENT WITH A FUNCTIONALIZED SURFACE

(71) Applicant: TRUMPF Laser- und Systemtechnik GmbH, Ditzingen (DE)

(72) Inventor: Felix Zimmermann, Ditzingen (DE)

(21) Appl. No.: 19/068,030

(22) Filed: Mar. 3, 2025

Related U.S. Application Data
(63) Continuation of application No. PCT/EP2023/073719, filed on Aug. 29, 2023.

(30) Foreign Application Priority Data
Sep. 9, 2022 (DE) 10 2022 122 968.8

(51) Int. Cl. C03C 23/00

(52) U.S. Cl. CPC C03C 23/0025

(57) ABSTRACT

A transparent component is provided. The transparent component includes a functionalized surface. The functionalized surface has dimples. Thereby, the functionalized surface of the transparent component is functionalized. The functionalized surface is functionalized by an anti-glare functionalization. A fill area of the dimples on the functionalized surface is between 20% and 95%.

### CROSS REFERENCE TO RELATED APPLICATIONS

This application is a continuation of International Application No. PCT/EP2023/073719 (WO 2024/052178 A1), filed on Aug. 29, 2023, and claims benefit to German Patent Application No. DE 10 2022 122 968.8, filed on Sep. 9, 2022. The aforementioned applications are hereby incorporated by reference herein.

### FIELD

Embodiments of the present invention relate to a transparent component with a functionalized surface.

### BACKGROUND

It is known that, during laser material processing, material from a component can be removed by vaporizing the material within the focal zone of the laser beam through a strong light-matter interaction. The resulting structures are called dimples.

In this regard, dimples are suitable for functionalizing the surfaces of components, wherein optical properties and tribological properties in particular can be influenced.

However, when processing a material with a pulsed laser, regular structures are often created, for example, by a beat between the repetition frequency of the laser system and other process parameters such as the feed rate and the number of repetitions of material passes. Such regular structures can, for example, lead to interference effects that disturb the visual impression of the processed material.

A method and a device for laser cutting, in particular for the laser cutting of stents, are known from EP 3 613 228 A1.

A method for structuring a substrate surface is known from DE 10 2017 006 358 A1.

A machining process with a random trigger function for an ultrashort pulse laser is known from US 2018/0207748 A1.

### SUMMARY

Embodiments of the present invention provide a transparent component. The transparent component includes a functionalized surface. The functionalized surface has dimples and is thereby functionalized. The functionalized surface is functionalized by an anti-glare functionalization. A fill area of the dimples is between 20% and 95%.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a microscopic image of a transparent component with anti-glare functionalization according to some embodiments; and

FIG. 2 shows a confocal microscope image of a transparent component with anti-glare functionalization according to some embodiments.

### DETAILED DESCRIPTION

Embodiments of the present invention provide an improved transparent component with a functionalized surface.

According to some embodiments, a transparent component with a functionalized surface is provided, wherein the surface has dimples and the surface is thereby functionalized. According to embodiments of the invention, the surface functionalization is an anti-glare functionalization.

Here, the transparent material of the component can be a material such as, for example, a polymer or a plastic. The material to be processed can also be a semiconductor, for example, an elemental semiconductor such as silicon or germanium, or a III-V semiconductor such as gallium arsenide, or an organic semiconductor or any other type of semiconductor. For example, the material can be a silicon wafer. In particular, the material can be a layer system, wherein each layer can be chosen from the group of metals, polymers, plastics or semiconductors. In particular, the material can also be glass, for example, sapphire or quartz glass.

“Transparent” can mean that the component is optically transparent, i.e., transparent to the wavelengths visible to the human eye. For example, the material can transmit visible light more than 80% or more than 85% or more than 90% or more than 95% or more than 99%. However, “transparent” can also mean that the material is transparent to the wavelength of a laser.

The dimples can be manufactured using a laser processing method. Thus, the laser provides the laser pulses of the laser beam, wherein the individual laser pulses form the laser beam in the beam propagation direction. The pulse duration of the laser pulses can be between 300 fs and 10 ps and/or the wavelength of the laser pulses can be between 300 nm and 3000 nm, preferably between 900 nm and 2200 nm.

This makes it possible to select a laser wavelength at which the material is transparent, so that the dimples can be introduced into the material via a nonlinear interaction. In addition, the short pulse duration can prevent unwanted heating of the material, which can lead to undesirable material stresses.

In addition, the laser can have a linear polarization, for example, the degree of polarization of the laser beam can be more than 80%, preferably more than 95%. The laser beam can also have a circular or elliptical polarization.

Instead of individual laser pulses, the laser can also provide laser bursts, wherein each burst comprises the emission of multiple laser pulses. Thus, for a certain time interval, the emissions of the laser pulses can follow each other very closely, at intervals of a few picoseconds to nanoseconds. In particular, the laser bursts can be GHz bursts, in which the sequence of successive laser pulses of the respective burst occurs in the GHz range. For example, a burst can contain between 2 and 10 laser pulses, with the time interval between the laser pulses being between 10 ns and 50 ns. However, a burst can also contain between 30 and 300 laser pulses, wherein the time interval between the laser pulses can be between 100 ps and 1000 ps.

For example, the length of the laser pulses can be between 100 ps and 100 ns, in particular between 1 ns and 20 ns, wherein the wavelength can be between 300 nm and 550 nm, in particular 355 nm, wherein the repetition frequency of the laser pulses can be between 10 kHz and 100 kHz, in particular between 10 kHz and 50 kHz, wherein the laser pulses can have an energy of between 60 μJ and 300 μJ and 1 to 4 pulses can be emitted per spot.

For example, the length of the laser pulses can be between 200 fs and 1000 fs, in particular between 300 fs and 450 fs, wherein the wavelength can be between 900 nm and 2300 nm, in particular 1030 nm, wherein the repetition frequency of the laser pulses can be between 10 kHz and 400 kHz, wherein the laser pulses are emitted in laser bursts, wherein each laser burst can contain between 2 and 4 laser pulses, wherein the laser bursts can have an energy of between 100 μJ and 400 μJ and the numerical aperture can be between 0.01 and 0.2, in particular 0.08.

The laser pulses are introduced into the material, wherein the energy of the laser beam is at least partially absorbed in the material, for example, by nonlinear interactions, in particular by multiphoton processes.

Here, the focus of the laser beam can be located in the beam propagation direction above the surface of the material to be processed, or under the surface in the volume of the material to be processed. The focal position can also be located precisely on the surface of the material to be processed. In particular, the focal position can be within ten times the Rayleigh length from the surface, where the Rayleigh length is the distance along the optical axis that a laser beam needs until its cross-sectional area doubles, starting from the beamwaist or the focus.

In particular, the term “focus” can generally be understood as a targeted increase in intensity, wherein the laser energy converges in a “focal range”. In particular, the term “focus” is therefore used below irrespective of the actual beam shape used and the methods used to bring about an increase in intensity. The location of the increase in intensity along the beam propagation direction can also be influenced by “focusing”. For example, the increase in intensity can be virtually punctiform and the focal range can have a Gaussian-shaped intensity cross-section, as is provided by a Gaussian laser beam. The increase in intensity can also be linear, wherein a Bessel-type focal range is created around the focal position, as can be provided by a non-diffractive beam. Furthermore, other more complex beam shapes are also possible, the focal position of which extends in three dimensions, for example, a multi-spot profile of Gaussian laser beams and/or non-Gaussian intensity distributions.

As a result of the energy absorbed from the laser beam, the material heats up in accordance with the intensity distribution of the laser and/or transitions into a temporary plasma state according to the electromagnetic interaction between the laser and the material. In particular, in addition to linear absorption processes, non-linear absorption processes can also be used, which become accessible through the use of high laser energies or laser intensities. Accordingly, the material is modified particularly in the focus of the laser, as this is where the intensity of the laser beam is greatest. What this can achieve, in particular, is that some of the material can be released from the material composite, for example, by melting or vaporizing it. Hence, machining processes known per se are possible in relation to the interaction between the laser light and the material to be processed, these methods being known, for example, as laser drilling, percussion drilling, or laser ablation.

The interaction of the laser pulses with the material to be processed creates dimples on the surface of the transparent component.

A dimple is created by the vaporization of the material on the surface due to the irradiated laser intensity. The material is vaporized particularly where the intensity of the laser beam exceeds a critical, material-specific processing threshold. Accordingly, the shape and form of the laser beam, especially the beam profile, is crucial for the shape and form of the dimples.

In the simplest case, the laser beam is a Gaussian laser beam with a Gaussian beam profile. There is a certain spatial area around the focal point in which the laser energy is above the critical threshold. In other words, there is an isointensity area in the intensity distribution of the laser beam at the focus within which the material can be vaporized. The shape and form of the dimple results from this isointensity surface.

In particular, dimples can therefore have a round or elliptical cross-section in the plane of the material surface, with the dimples having an increasing depth from the edge to the center. In particular, the cross-section of the dimples in the plane perpendicular to the surface can also be round or rounded.

By introducing dimples onto the surface of the material, the optical properties of the material can be determined, for example, by scattering light passed through a transparent material at the dimples, thus making the material appear diffuse and/or matt. In particular, dimples on the surface of the material can reduce reflection from the material.

For example, the feel or roughness can be adjusted by the type and shape of the dimples, as well as the distribution of the dimples on the surface of the component. However, it is also possible to adjust the scattering of light and thus the optical properties of the material.

An anti-glare functionalization can then consist of an incident light beam not only being reflected from the surface at the angle of reflection according to Snell's law of refraction. In particular, it can also be the case that the incident light beam is reflected or scattered from the surface at other angles. In particular, the incident light beam is guided in different spatial directions so that no sharp reflection occurs, in the sense that the entire energy of the incident light beam can be detected at a certain angle of incidence. Rather, the energy of the incident light is distributed over a spatial area so that the energy of the incident light beam can be detected in a range of angles of reflection.

The dimples can be randomly arranged on the surface.

A random arrangement can occur if the spatial distances between the dimples have a random size. The spatial distances result from the center distances or the minimum distances from dimple edge to dimple edge.

In particular, for example, a spatial frequency distribution of the dimples results from the spatial distribution of the dimples, including the size of the dimples, via a Fourier transformation. The more irregular the distances between the dimples are, the larger the bandwidth of the spatial frequency distribution, and the more diffusely an incident light beam is reflected by the transparent component.

In particular, “randomly arranged” can mean that the dimples are randomly distributed in the spatial frequency space. By displaying the position of the dimples in the spatial frequency domain, it is also possible to identify potential spatial directions along which interference of the reflected or transmitted light could occur to optimize the arrangement.

“Randomly distributed” can also mean that the spatial distribution of the dimples follows a random distribution, for example, a uniform distribution.

This has the advantage that the dimples are introduced into the material at an irregular distance from one another such that disruptive optical effects, for example, such as interference, are reduced or avoided.

For example, the transparent component can be used to avoid a moiré effect, for example when the material is placed over a display panel with an underlying pixel grid. The moiré effect typically occurs when the pixel period of the display panel is on the same order of magnitude as the period of the dimple arrangement. By randomly arranging the dimples on the surface of the material, a moiré effect can be avoided because the pixel period does not produce a beat with a dimple period.

The functionalized surface can be designed to reduce direct reflection.

Direct reflection, for example, is a zero-order diffraction at the dimples of the surface of the transparent component. Direct reflection is suppressed if less than 90%, preferably less than 70%, particularly preferably less than 50% of the incident light is reflected at the angle of reflection according to Snell's law of refraction.

The sparkle of the surface with anti-glare functionalization can be less than 5%.

“Sparkle” describes an optical effect that is noticeable as glittering or sparkling of the transparent component when light is reflected from the surface of the component or is transmitted through the transparent component. The appearance depends strongly on the chosen angle of incidence of the light and the angle of observation. The sparkle is therefore a measure of the irregular intensity and color fluctuations.

The sparkle can, for example, be quantified as the intensity modulation of the light by the sparkle, in particular the intensity increase or the intensity decrease in a uniform illumination.

By means of anti-glare functionalization, such sparkling can be suppressed and the transmission and reflection can be homogenized.

For example, if the transparent component is placed over a display with a particularly high resolution, it is advantageous to reduce the size of the dimples to ensure a slight sparkle. In particular, the size of the dimples can be smaller than the size of the pixels.

The distinctness of image can be more than 70%.

The distinctness of image (DOI) describes the image sharpness and quantifies the deviation of the theoretical light propagation due to the scattering of light at the dimples. A “high DOI” means in particular a high image sharpness. The scattering of light at the dimples influences both the transmission and the reflection of light at or through the surface. With a low DOI, there is a large scattering of light, while with a high DOI there is little scattering of light and thus a high image sharpness is possible. The DOI therefore scales inversely with the scattering or diffusion. In particular, the DOI can also be set via the so-called area coverage of the surface with dimples (see below).

The diffusion can be more than 22%.

The diffusion is a measure of the scattering strength of the material. In particular, the diffusion also depends on the shape and nature of the individual dimples, so that the diffusion can be adjusted via the beam shape of the laser beam and the size and depth of the dimples.

The dimples can have a depth of between 100 nm and 2000 nm, preferably between 200 nm and 1000 nm.

This makes it particularly advantageous to adjust the roughness of the surface while avoiding extensive weakening of the material. However, the depth of the dimples can also be used to adjust the sparkle, DOI, and diffusion.

The dimples can have a diameter of between 3 μm and 30 μm, preferably between 3 μm and 10 μm. The dimples can also have a diameter of between 13 and 20 μm.

The sparkle, DOI, and diffusion can be particularly easily adjusted using the diameter of the dimples.

In particular, the diameter of the dimples can be used to optimize the anti-glare functionalization for any underlying optical structures, for example, pixels of displays.

The dimples can have a size variation relative to the diameter of between 5% to 80%.

For example, the size variation can be 50% and the diameter of the dimples can be 20 μm. Then the dimples on the surface can have diameters of between 10 μm and 30 μm. The sparkle, DOI, and diffusion can be adjusted via the diameter of the dimples.

The roughness of the transparent component can be between 0.05 μm and 1.5 μm.

This can create a particularly high-quality haptic impression of the surface.

The surface roughness can be defined as a peak-to-valley value, i.e., the distance from the highest elevation to the lowest depression. However, it can also be that the roughness is defined as the standard deviation of the depth of the dimples.

The fill area of the surface with dimples can be between 20% and 95%.

The fill area of the surface is given by the area ratio of the processed surface by the dimples and the total surface of the transparent component. Depending on the desired roughness or desired diffusion of the transparent component, the fill area of the surface can be adjusted.

In particular, when machining the surface, the dimples can also be introduced successively or in several passes, wherein the surface coverage is successively increased, while distortion or smearing of the dimples is reduced.

In particular, at least two dimples can spatially overlap.

“Spatial overlap” can mean that the dimples touch at the edge, or that the dimples partially lie on top of each other, i.e., that a surface intersection of the dimples exists.

In a preferred embodiment of the transparent component, the sparkle of the surface with the anti-glare functionalization is less than 5%, the distinctness of image is more than 70% and the diffusion is more than 22%, wherein the dimples have a depth of between 100 nm and 2000 nm, a diameter of between 3 μm and 30 μm and a size variation relative to the diameter of between 5% and 80%, wherein the roughness of the functionalized surface is between 0.05 and 1.5 μm and the fill area of dimples is between 20% and 95%.

In a particularly preferred embodiment of the transparent component, the sparkle of the surface with the anti-glare functionalization is less than 5%, the distinctness of image more than 70% and the diffusion more than 22%, wherein the dimples have a depth of between 200 nm and 1000 nm, a diameter of between 3 μm and 10 μm and a size variation relative to the diameter of between 5% and 80%, wherein the roughness of the functionalized surface is between 0.05 and 1.5 μm and the fill area of dimples is between 20% and 95%.

The transparent component can be a cover part or protective part of a smart device.

In particular, what are termed smart devices could be electronic devices that are touch-sensitive and can be controlled by finger gestures, for example, smart watches, smartphones, tablets, but also image display devices in cars, etc. In general, smart devices include screens and displays.

However, it can also be the case that the transparent component is arranged on the back of a smart device and gives the back a particularly high-quality and non-slip surface finish through its matt surface and the roughness caused by the dimples.

The transparent component can be arranged over a pixel matrix of a display of a smart device, wherein the dimples are smaller than the pixels.

For example, the transparent component can be arranged above the active matrix of a display panel, wherein the active matrix has electronically controllable pixel points that together form the image of the display. The transparent component can therefore protect and cover the underlying active matrix from mechanical influences.

By making the dimple size, especially the dimple diameter, smaller than the pixel size, a moiré effect can be avoided, in particular.

Preferred exemplary embodiments are described below with reference to the figures. In this case, elements that are the same, similar, or have the same effect are provided with identical reference symbols in the different figures, and a repeated description of these elements is omitted in some instances to avoid redundancies.

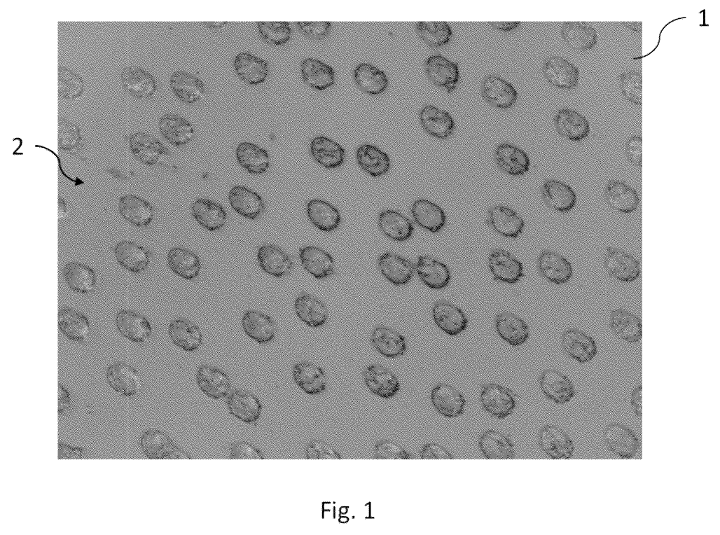

FIG. 1 shows a microscope image of a transparent component 1 with a surface functionalized by dimples 2, wherein the functionalization is an anti-glare functionalization. So-called dimples 2 were impressed on the surface of the transparent component 1 by corresponding laser pulses of a laser, for example, by two laser pulses of a laser pulse. The dimples 2 appear as round to oval ablated defects in the surface of the transparent component. In particular, each dimple 2 can be generated individually by two laser pulses of a laser burst.

The transparent material of component 1 can be, for example, sapphire or quartz glass.

As can be seen in FIG. 1, the dimples 2 are randomly arranged on the component, wherein the dimples 2 can also partially overlap or be adjacent to one another. By applying the dimples 2 in an irregular pattern to the surface of the transparent component 1, the direct reflection of an incident light beam can be suppressed in particular, since the incident light beam is refracted by the dimples 2 into a plurality of partial beams and reflected away.

Through such a modification of the surface by the dimples 2, the sparkle of the surface with the anti-glare functionalization can be less than 5%, the distinctness of image can be more than 70%, and the diffusion can be more than 22%.

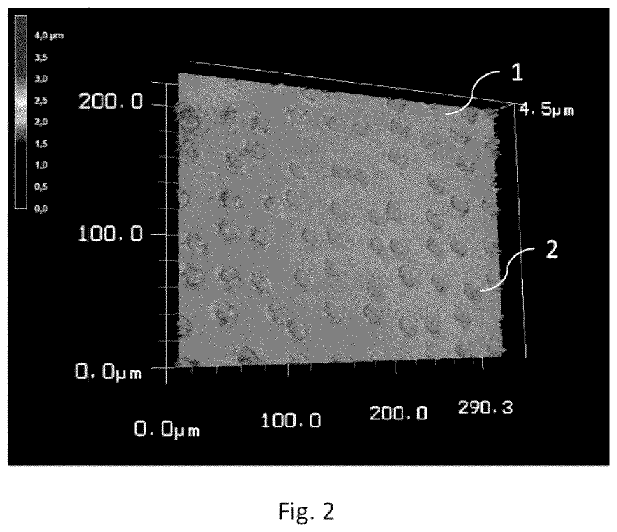

The same transparent component 1 is shown in the dimensioned confocal microscope image of FIG. 2. The dimples have a depth of between 100 nm and 2000 nm, for example, 500 nm. The dimples also have a diameter of between 3 μm and 30 μm, for example, 20 μm. The dimples also have a size variation relative to the diameter of between 5% and 80%, for example, 10%. In addition, the fill area of the surface with the dimples 2 is between 20% and 95%, for example, 30%.

These values make it particularly easy to adjust the parameters for sparkle, DOI, and diffusion.

For example, the transparent component 1 can be arranged on the display panel of a smart device so that the transparent component 1 functions as a protective or covering layer. In particular, the haptic quality can be adjusted by the roughness of the transparent component through the dimple size. In addition, the formation of a moiré effect can be avoided by a random arrangement of the dimples 2 and/or a dimple size that is smaller than the pixel size (not shown).

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Transparent component
2 Dimple

1. A transparent component comprising:
a functionalized surface, wherein the functionalized surface has dimples and is thereby functionalized,
wherein
the functionalized surface is functionalized by an anti-glare functionalization, and a fill area of the dimples is between 20% and 95%.

2. The transparent component according to claim 1, wherein the dimples are randomly arranged on the functionalized surface.

3. The transparent component according to claim 1, wherein the functionalized surface reduces direct reflection.

4. The transparent component according to claim 1, wherein a sparkle of the surface with the anti-glare functionalization is less than 5%.

5. The transparent component according to claim 1, wherein a distinctness of an image is more than 70%.

6. The transparent component according to claim 1, wherein a diffusion is more than 22%.

7. The transparent component according to claim 1, wherein the dimples have a depth of between 100 nm and 2000 nm.

8. The transparent component according to claim 1, wherein the dimples have a depth of between 200 nm and 1000 nm.

9. The transparent component according to claim 1, wherein the dimples have a diameter of between 3 μm and 30 μm.

10. The transparent component according to claim 1, wherein the dimples have a diameter of between 3 μm and 10 μm.

11. The transparent component according to claim 1, wherein the dimples have a size variation relative to a diameter of between 5% and 80%.

12. The transparent component according to claim 1, wherein a roughness of the functionalized surface is between 0.05 and 1.5 μm.

13. The transparent component according to claim 1, wherein at least two dimples spatially overlap.

14. The transparent component according to claim 1, wherein the transparent component is a cover part or a protective part of a smart device.

15. The transparent component according to claim 1, wherein the transparent component is arranged above a pixel matrix of a display of a smart device, wherein the dimples are smaller than pixels of the pixel matrix.
